(19) United States
(12) Patent Application Publication
(10) Pub. No.: US 2007/0098483 A1
(43) Pub. Date: May 3, 2007

(54) Cosmetic Product Distributor-Applicator

(76) Inventors: Frederic Milesi, Paris (FR); Fabrice Dieudonat, Fosses (FR)

Correspondence Address: BANNER & WITCOFF, LTD., 1100 13th STREET, N.W., SUITE 1200, WASHINGTON, DC, 20005-4051, US

(21) Appl. No.: 11/551,855

(22) Filed: Oct. 23, 2006

(30) Foreign Application Priority Data
Oct. 21, 2005 (FR) 05 10740

(51) Int. Cl. B43K 7/00

(52) U.S. Cl. 401/209

(57) ABSTRACT

A distributor-applicator includes a body having a container for containing a product and application means integrated with the container. The application means can be in communication with the container through an upper opening and includes an application surface for application of the product, and a cap cooperating with the body so as to protect the application means when the distributor-applicator is not being used. The body includes a vibration generator, a power source, an associated electric circuit, and a switch for starting and stopping the generator.

### BACKGROUND

Ball distributor-applicators are shown, for example, in U.S. Pat. No. 5,810,495, which describes a distributor, typically for a low-viscosity liquid product, including a head equipped with a ball mounted on a spring, as well as an annular valve. Similarly, GB 2 044 683-A describes a tube of which the head includes an application ball, while FR 2 836 345, in the applicant's name, describes a ball measuring applicator. Distributor-applicators with a stationary application surface, as described, for example, in patent applications US 2003 0057236 and US 2002 0014254 are also known.

On one hand, cosmetic products are constantly being developed so as to obtain advantageous new characteristics, but the packaging means are not always suitable for these new products, in particular when these products have a rheology unsuitable for the conventional packaging means.

Second, new application means for the application of all types of products are constantly being sought, so as to obtain advantageous application effects.

Finally, in the field of cosmetic product packaging, with the exception of the specific field of perfumes, there is a constant demand for renewal of the supply of novel products, wherein the novelty concerns the container and/or the contents, and the novelty is generally accompanied by new advantages or performances going beyond simple issues of shape or aesthetics.

### BRIEF SUMMARY

In one aspect, a distributor-applicator of a fluid or pasty product, typically a cosmetic product, typically has an axial direction, and includes a body including a container forming a main cavity capable of containing said product. An application means, integrated with said container, closes off said main cavity at its upper portion. The application means can be in communication with said container, typically owing to an upper opening, so that said application means can be supplied with said product, and including an application surface for application of said product on a part of the human body, for example the facial skin, and a cap equipped with a head and a skirt cooperating with said body so as to protect said application means when said distributor-applicator is not being used and is said to be “closed”.

It is characterised in that said body includes a device capable of generating vibrations, typically periodic vibrations, said device including a vibration generator, for example and electrical vibrator, a power source, constituted for example by an electric battery, and an associated electric circuit for supplying power to said vibration generator, and means for starting and stopping said vibration generator, typically a switch of said electric circuit, so that, during said application of said product on said support, said application means can produce in particular a massaging effect on said support, said vibration generator being activated during all or part of said application.

The distributor-applicator solves the stated problems. First, the vibrations emitted by the vibration generator are necessarily transmitted to the product contained in said container, which thereby enables the flow and application of a product that, in the absence of vibrations would have, for example, significant Theological rigidity, or a high thixotropy, making it difficult if not impossible to apply. Second, said product is applied, typically on a part of the human body, for example on the skin, the lips, etc., while the application surface of the application means vibrates, which can have numerous favourable effects with regard to the speed of penetration of the product into the skin, and the massaging effect obtained, which is perceived as pleasant.

Moreover, the distributor-applicator according to the invention stands out entirely from conventional distributor-applicators. Finally, the invention allows for the production of a large number of embodiments, which allow for adaptation of the container both to the nature of the contents and to the specific needs of the users, the invention including distributor-applicators equipped with either a mobile or fixed application surface.

### BRIEF DESCRIPTION OF THE DRAWINGS

The features, and advantages of the invention will be apparent from the following more detailed description of certain embodiments of the invention and as illustrated in the accompanying drawings in which:

FIGS. 1a to 7d relate to a first embodiment of a distributor-applicator 1 in which said application means 4 include a rotatable part 44 forming a hollow roller 44′″.

FIGS. 1a to 1e show the distributor-applicator 1 closed, the cap 5 snapped onto the body 2. In these figures, the distributor-applicator 1 does not include said vibration generator 60 shown in FIGS. 2a to 2f, so as not to complicate the figures.

FIG. 1a is an axial cross-section view of a plane including said axial direction 10 and said transverse direction 11.

FIG. 1b is an axial cross-section view of a plane including said axial direction 10, perpendicularly to said transverse direction 11, in the plane B-B of FIG. 1a.

FIG. 1c shows a partial axial cross-section view of a plane including said axial direction 10, perpendicularly to said transverse direction 11, in the plane C-C of FIG. 1a.

FIG. 1d is a perspective view.

FIG. 1e is a bottom view.

FIGS. 2a to 2f relate to the vibration generating device 6 and to its assembly to said body 2, said generating device 6 including in particular a vibration generator 60 and an energy source 61 housed inside said hollow roller 44′″.

FIGS. 2a and 2b are partial cross-sections analogous to that of FIG. 1a, which show an automatic switch 63′ of said vibration generating device 6. In these two figures, only the application means 4 has been shown, the container integrated with the application means 4 not having been shown so as not to complicate the figures.

In FIG. 2a, the distributor-applicator 1 is closed, the cap 5 being snapped on to the body 2 application means 2, so that said electric circuit 62 of said generating device 6 is open, thus preventing said generator 60 from functioning.

In FIG. 2b, the distributor-applicator 1 is open, the cap 5 being separated from the body 2 application means 4, so that said electric circuit 62 of said generating device 6 is automatically closed, thus enabling said generator 60 to function.

FIGS. 2c to 2f relate to the vibration generator 60.

FIG. 2c is a side view of the generator 60 that includes an electric motor 600 and an unbalanced part 602 mounted on the motor spindle 601.

FIG. 2d is a side perspective view of the generator 60.

FIG. 2e is a rear or right view of the generator 60 of FIG. 2c.

FIG. 2f is a front or left view of the generator 60 of FIG. 2c.

FIGS. 3a to 3e relate to the support 44 of the hollow roller 44′″, which support is intended to be assembled to the container 3. In these figures, the support 44 has been shown without the valves 7, shown in FIGS. 4a to 4f, so as not to complicate the figures.

FIG. 3a is a cross-section view analogous to that of FIG. 1a.

FIG. 3b is a side view corresponding to the orientation of the support 44 of FIG. 3a.

FIG. 3c is a bottom view.

FIG. 3d is a cross-section view in the axial plane B-B of FIG. 3a.

FIG. 3e is a perspective view on a different scale.

FIGS. 4a to 4f relate to the valves 7 intended to cooperate with said support 44.

FIG. 4a is an axial cross-section view of plane A-A of FIG. 4b including said axial direction 10. Said valve 7 includes a central portion acting as a closure element 70, a peripheral portion 71 for assembly to the support 45 and an intermediate portion 72 having a spring force urging said central portion 70 upward.

FIG. 4b is a top view.

FIG. 4c is a side view that is a view of the front surface of the valve of FIG. 4b.

FIG. 4d is a side view that is a view of the rear surface of the valve of FIG. 4b.

FIGS. 4e and 4f are partial cross-sections analogous to the cross-section according to FIG. 1c, which show the operation of said valves 7.

FIG. 4e shows the case in which the valve 7 is open, so as to allow for a flow of said product from the container to the roller 44′″, said valve 7 having undergone an axial downward movement due to an axial movement of said roller 44′″ due to the pressure exerted on said roller 44′″ during the application of said product 9, which pressure is shown with an arrow in FIG. 4e.

FIG. 4f shows the case in which the valve 7 is closed, so as to prevent any flow of product 9 toward said roller 44′″.

FIGS. 5a to 5g relate to the container 3 forming the lower portion of the body 2.

FIG. 5a is a side view, the container 3 being oriented according to a plane containing said axial 10 and transverse 11 directions.

FIG. 5b is a side view, the container being oriented according to a plane containing said axial direction 10 and perpendicularly to said transverse direction 11.

FIG. 5c is an axial cross-section corresponding to FIG. 5a.

FIG. 5d is a top view.

FIG. 5e is a side and top perspective view.

FIG. 5f is an axial cross-section corresponding to FIG. 5b.

FIG. 5g is an enlarged view of the portion of FIG. 5c surrounded by a circle referenced “C”.

FIGS. 6a to 6g relate to the cap 5.

FIG. 6a is an axial cross-section analogous to that of FIG. 5c.

FIG. 6b is an axial cross-section analogous to that of FIG. 5f.

FIG. 6c is a top view.

FIG. 6d is a bottom view.

FIG. 6e is a partial axial cross-section according to plane D-D of FIG. 6d.

FIG. 6f is a side and top perspective view.

FIG. 6g is an enlarged view of the portion of FIG. 6e surrounded by a circle referenced “E”.

FIGS. 7a to 7d relate to the hollow roller 44′″ constituted by two hollow half-shells 440, 440′, a first half-shell 440 acting as a tubular recipient, a second half-shell 440′ acting as means for closing said tubular recipient.

FIG. 7a is a perspective view of the two half-shells 440, 440′ opposite one another before their snapping assembly in said transverse direction 11.

FIG. 7b is a cross-section view according to said transverse direction 11, of said first half-shell 440.

FIG. 7c is a cross-section view according to said transverse direction 11, of said second half-shell 440′.

FIG. 7d is a front view of said first shell 440.

FIGS. 8a to 8f show alternatives of an embodiment of distributor-applicators 1 according to the invention.

FIG. 8a is a side view of closed distributor-applicators corresponding to these embodiments.

FIGS. 8b to 8f are analogous and show various alternatives of distributor-applicators, each figure including an upper portion corresponding to an axial cross-section of said closed distributor-applicator, and a lower portion, which is a top view of the application means 4.

FIGS. 9a and 9b show another embodiment of the distributor-applicator.

FIG. 9a is a diagrammatic axial cross-section of a body 2, the cap 5 not being shown.

FIG. 9b is an enlarged view of the portion of FIG. 9a surrounded by a circle referenced “A”.

FIG. 9c is an axial cross-section view showing the case in which said body 2 forms a tube 2′ shown with its base 22 open, the tube being ready to be filled with a product 9.

FIG. 9d is analogous to FIG. 9a and shows an alternative distributor-applicator 1 with a plunger.

FIG. 9e, which is equivalent to FIG. 9b, is an enlarged view of the portion of FIG. 9d surrounded by a circle referenced “D”.

### DETAILED DESCRIPTION

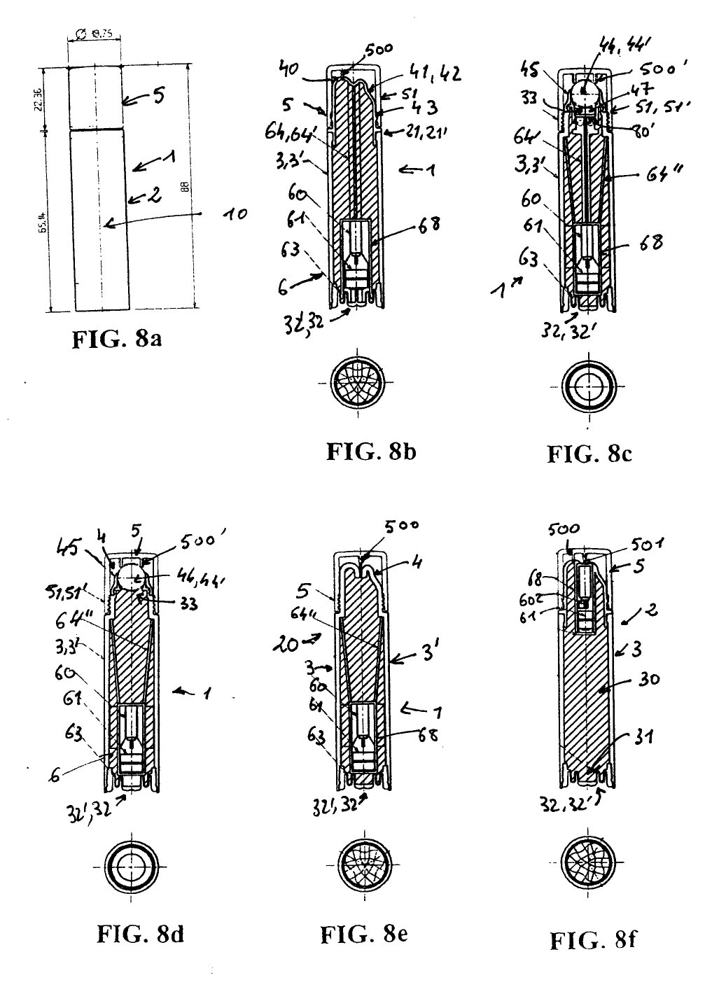

According to the invention, said vibration generator 60 can be integrated with said body 2, and typically integrated with said container 3, said vibrations transmitted by said vibration generator being transmitted from said body 2 to said application means 4, said vibration generator 60 being typically contained in said main cavity 30. The vibration generator 60, and at least the power source 61 are housed in said container 3 in the case of the distributor-applicators shown in FIGS. 8b to 8f.

As shown in FIGS. 8b to 8e, said device 6 can include means 64 for transmitting said vibrations from said vibration generator 60 to said application means 4, said means typically forming a rod 64′ integrated at one end with said vibration generator 60 and at the other end with said application means 4.

As shown, for example, in FIGS. 8b to 8e, said device 6 can include means 64 for transmitting said vibrations from said vibration generator 60 to said application means 4, said transmission means 64 typically forming a rod 64′ integrated at one end with said vibration generator 60 and at the other end with said application means 4.

As shown in FIG. 8f, said vibration generator 60 can be integrated with the application means 4 so as to directly transmit said vibrations from said vibration generator 60 to said application means 4.

According to a first embodiment of the invention, and as shown in FIGS. 8b, 8e and 8f, said application means 4 can include a central membrane 42 capable of responding the mechanical stresses imposed by said vibration generator 60, typically in said axial direction 10, said central membrane 42 typically including at least said upper opening 40 in communication with said container 3.

Said central membrane 42 of said application means 4 can form all or some of a distinct part of said container 3, said application means 4 typically including a peripheral portion 43, typically rigid, intended to cooperate with an upper opening 33 of said container 3, said distinct part typically being a moulded plastic part.

As shown in FIG. 8e, said central membrane 42 can form a one-piece moulded part with all or part of said container 3.

As can be seen in FIGS. 8b, 8e and 8f, said central membrane 42 can have a relief, with relief portions 420 and hollow portions 421, so as to obtain a massaging effect.

As shown in FIGS. 8b and 8e, the head 50 of said cap 5 can include a first axial projection 500 capable of closing off said upper opening 40 when said cap 5 cooperates with said body 2, said distributor-applicator 1 being closed.

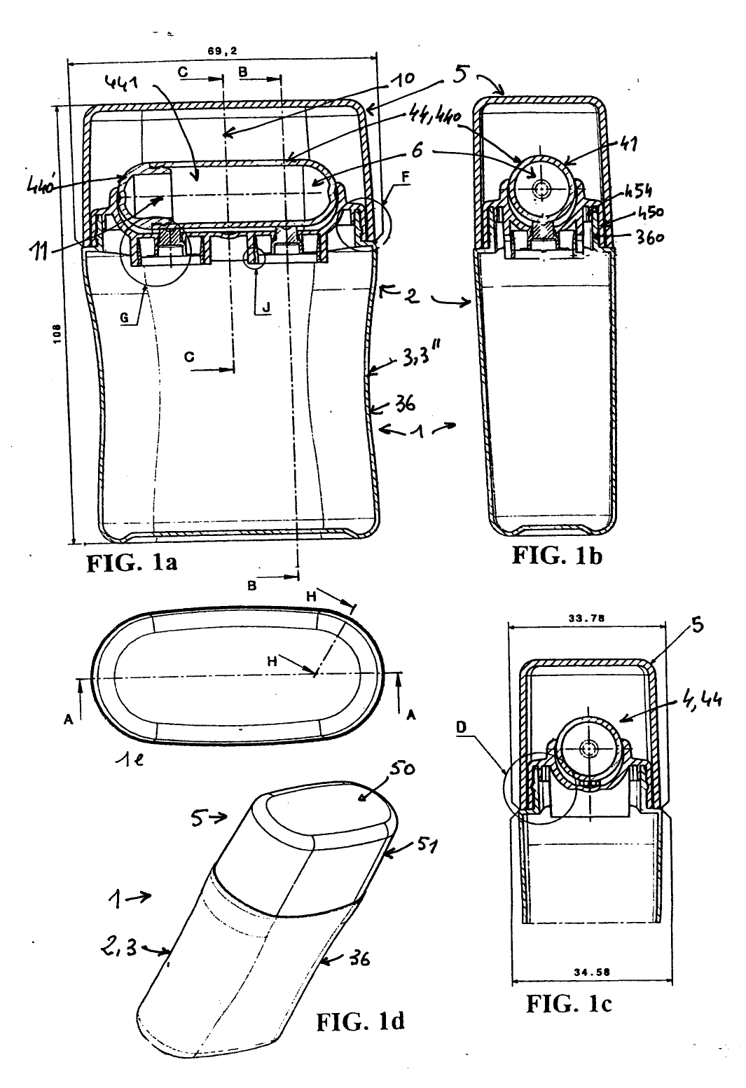

According to a second embodiment of the invention, and as shown in FIGS. 1a, 8c and 8d, said application means 4 can include a part 44 rotatable with respect to said container 3, and a support 45 for said mobile part 44 equipped with an opening 452 putting said container 3 and said mobile part 44 in communication, said support 45, integrated with said container 3, cooperating with said mobile part 44 so that said mobile part 44 can rotate about itself during said application of said product, without said mobile part 44 being capable of being involuntarily separated from said support 45, said mobile part 44, rotating about itself, ensuring an automatic transfer of said product 9 from said container 3 to said application surface 41 formed by the external surface of said mobile part 44.

According to an alternative, and as shown in FIGS. 8c and 8d, said mobile part 44 can be formed by at least one ball 44′, said support 45 typically including at least one circular lip 450 or a plurality of lugs surrounding said ball 44′ so that said ball 44′ can rotate about itself without being separated from said support 45.

According to another alternative, and as shown with the distributor-applicator shown in FIGS. 1a to 7d, said mobile part 44 can be formed by a longitudinal part or a roller 44″ capable of rotating about itself in a transverse direction 11 perpendicular to said axial direction 10, said support 45 including an upper cavity 46 typically equipped with an upper peripheral lip 451, having a shape matching that of said roller 44″, so that said roller 44″ can be snapped into said upper cavity 46, and said roller 44′, once snapped into said upper cavity 46, has, with respect to said support 45, a sufficient play to allow for rotation of said roller 44″ in said transverse direction 11 when said product is applied.

As shown in particular in FIG. 1a, said roller 44″ can be a hollow roller 44′″ formed by an assembly of two hollow half-shells 440, so as to form a so-called secondary cavity 441 when the two hollow half-shells 440 are assembled.

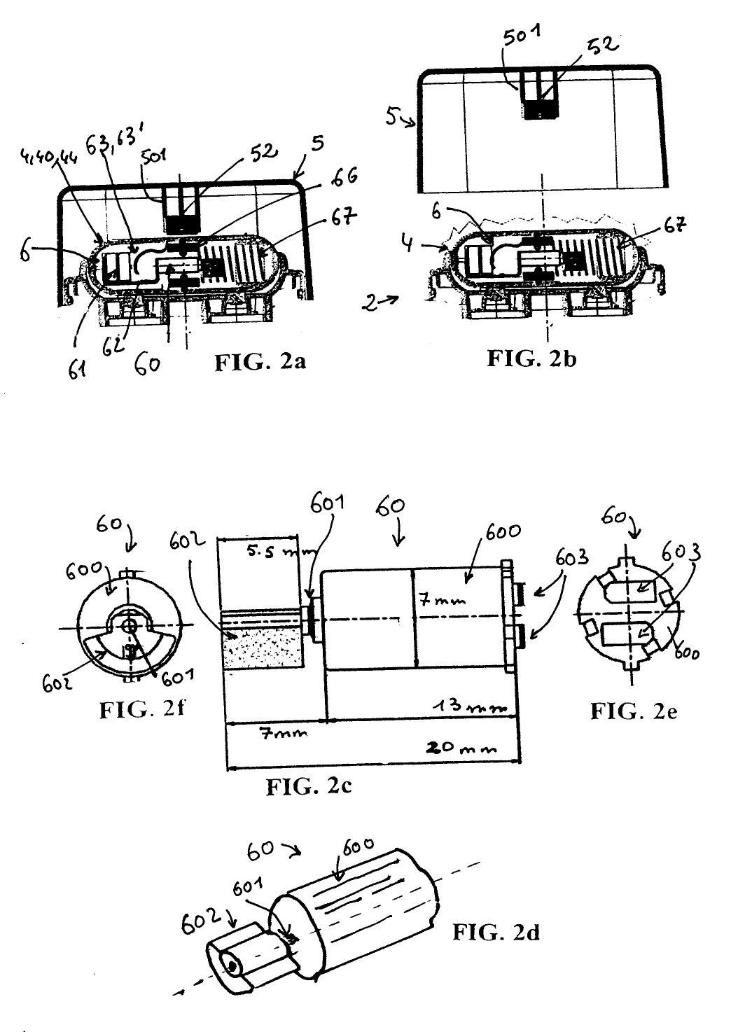

As shown in FIGS. 2a and 2b, said vibration generator 60 can be housed in said secondary cavity 441. Thus, according to an alternative embodiment, at least said power source 61 and all or part of said switch 63 of said electric circuit 62 can be housed in said secondary cavity 441.

As shown in FIGS. 8b to 8f, and according to another alternative embodiment, said power source 61 and/or said switch 63 of said electric circuit 62 are housed outside said secondary cavity 441 and are typically housed in said container 3.

According to the invention, said switch 63 can include a mobile element 65 for switching off said electric circuit 62, said mobile element 65 being capable of switching from a so-called “open” position to a so-called “closed” position in order to open/close said electric circuit 62. Said mobile element 65 can be located in the upper portion of the distributor-applicator 1, as shown in FIGS. 2a, 2b and 8f, or in the lower portion of the distributor-applicator 1, as shown in FIGS. 8b to 8e.

As shown in FIGS. 2a, 2b and 8f, said cap 5 can cooperate with said mobile element 65 so as to form an automatic switch 63′, typically thanks to a second axial projection 501 of said cap 5, said electric circuit 62 being “open” when said cap 5 cooperates with said body 2, and said electric circuit 62 being “closed” when said cap 5 is separated from said body 2, so that said vibration generator 60 functions only when said cap 5 is separated from said body 2, said vibration generator 60 automatically stopping when said cap 5 is secured to said body 2, typically by snapping or by screwing.

As shown in FIGS. 2a and 2b, said second axial projection 501 of said cap 5 can include a so-called upper magnet 52 and said mobile element 65 of said switch 63 can include a so-called lower magnet 66, said upper 52 and lower 66 magnets being arranged so that said upper magnet 52 drives a movement of said lower magnet 66 forming said mobile element 65 to the “open” position when said cap 5 cooperates with said body 2, a return spring 67 causing said mobile element 65 to move to the “closed” position when said cap 5 is separated from said body 2.

According to the invention, said vibration generator 60 can transmit periodic vibrations with a frequency v ranging from 20 Hz to 60 Hz.

Said vibration generator 60 can transmit axial vibrations in said axial direction 10. However, particularly depending on the orientation of said vibration generator 60 with respect to said body 2, said vibration generator 60 can transmit transverse vibrations in said transverse direction 11.

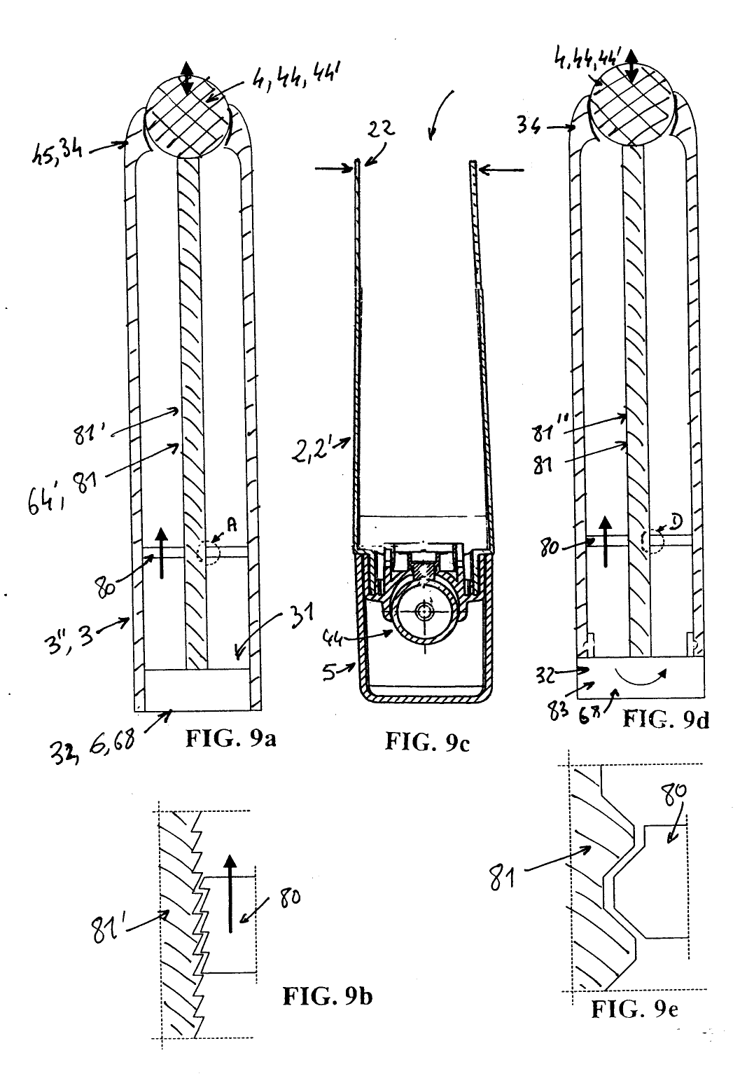

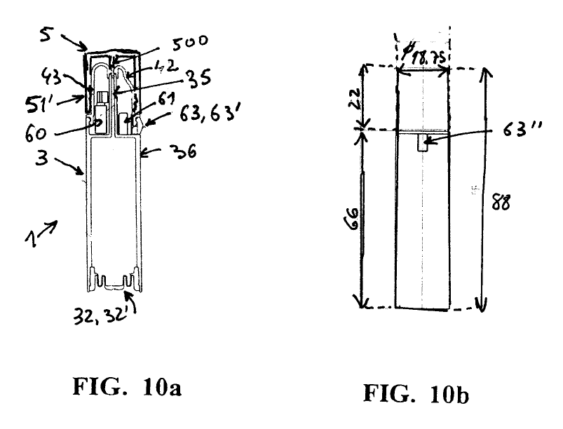

As shown in FIGS. 9a to 9d, said container 3 can include means for propulsion 8 of said product 9 toward said application means 4, said propulsion means typically including a plunger 80. However, as shown in FIG. 9c, these propulsion means can be constituted by the use of a flexible tube that simply needs to be manually pinched in order to eject said product 9 from said container 3 and to urge said product 9 toward said application means 4.

As shown in FIGS. 9a and 9b, said plunger 80 can be moved axially in said container 3 by said axial vibrations, typically with an axial rod 81 integrated with said vibration generator 60 and transmitting, to said plunger 80, a series of axial micro-movements, owing to non-return means 82 preventing said plunger, after each micro-movement in the direction of said application means 4, from moving backward, so as to automatically supply said application means 4 with product 9, regardless of the orientation of said container 3, or possibly the viscosity of said product 9.

However, as shown in FIGS. 9d and 9e, said plunger 80 can be fixed in rotation to a manual rotation button 83, and this button 83 can house all or part of said vibration generating device 6, and in particular said vibration generator 60, an axial manual pressure exerted on the base of said button 83 being sufficient for electrical contact with the inside of said button, so as to form said switch 63.

According to the invention, and as shown in FIGS. 8a to 8f, said distributor-applicator 1 can have a cylindrical shape, with a diameter D ranging from 12 to 25 mm in a transverse plane, a height H ranging from 60 mm to 100 mm in said axial direction, and a shape factor H/D ranging from 3 to 6, said distributor-applicator 1 being closed.

However, as shown in FIGS. 1a to 7d, said distributor-applicator 1 can have a non-cylindrical shape with, in a transverse plane, a larger dimension D1 ranging from 50 mm to 90 mm, a smaller dimension D2 ranging from 20 mm to 50 mm, and a height H ranging from 90 mm to 130 mm in said axial direction 10.

As shown in FIG. 9c, said body 2 can be a body forming a tube with a flexible wall 2′, typically made of plastic, said tube 2′ including an open base 22 for its refilling with said product, said base 22 then being closed by sealing.

As shown in FIGS. 8b to 8f and 10a, said container 3 of said body 2 can be a container 3′ including a lower opening 31 intended for the filling of said container 3 by the base, and means 32 for closing off said lower opening 31, typically formed by closure means with elastic return 32′, typically a membrane with elastic return forming an end cap, or by an end cap. Said closure means with elastic return 32′ make it possible, when pressure is manually applied to the base of the distributor, to establish electrical contact, and thus to activate said vibration generator 60, and/or urge a fraction of said product toward said application surface 41, said distributor 1 possibly being upside-down.

The elastic return of said closure means 32 can also be obtained by lateral rods 64″ or an axial rod 64′, which can also form said vibration transmission means 64, as shown in FIGS. 8c to 8e.

As shown in FIG. 8e, said container 3 and said support 45 or said central membrane 42 can form a one-piece plastic moulded part 20.

As shown in FIG. 1a, said container 3 can be a container 3″ including a base without an opening, said container 3″ including said upper opening 33 making it possible to fill said container 3″ by the top, said application means 4 being assembled to said container, typically by axial snap-on means, after filling said container 3″ by the top.

As shown in FIGS. 1a, 1b, 44e and 4f, said opening 452 of said support 45 can cooperate with a closure valve 8, said valve 7 being capable of moving with respect to said opening 452 according to an axial path over an axial distance ranging from 0.5 to 3 mm, said valve 7 typically including a central portion 70 intended to close off said opening 452, a peripheral portion 71 ensuring assembly with said support 45, an intermediate portion 72 having an elastic return with a spring force urging said central portion toward said mobile part 44, so that said opening 452 is closed off by said central portion 70 when said mobile part 44 exerts an axial pressure on said central portion, when said product 9 is applied.

As shown in FIGS. 8b to 8f, all or part of said vibration generating device is placed in a box 68 housed in said container, said box typically forming a moulded part integral with said transmission means 64 or said rod 64′.

Said box 68 can form said closure means 32 of said container 3 at its lower portion, said switch 63 being activated and said electric circuit being closed by a manual pressure exerted on said box 68.

The invention also relates to the use of a distributor-applicator 1 according to the invention for the packaging of a cosmetic product or a dermatological product 9, to be applied to the face, on the hands or on the skin.

### EXAMPLE 1

This example describes producing the distributor-applicator 1 according to FIGS. 1a to 7d.

To do this, the following parts were molded with plastic material or were supplied:

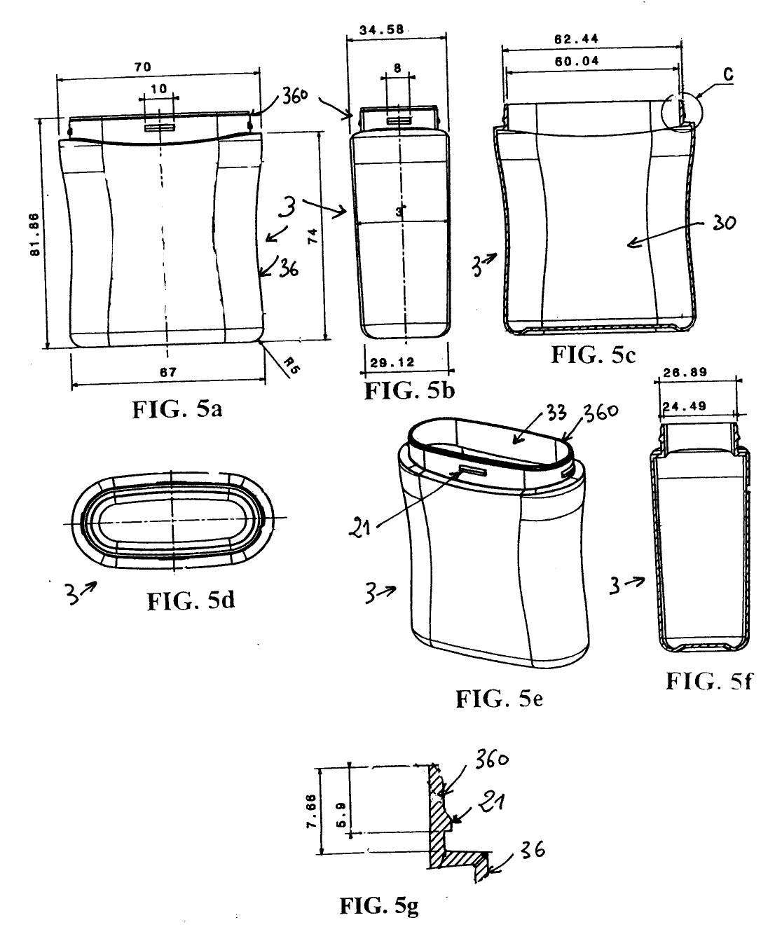

a container 3, 3″ according to the drawings of FIGS. 5a to 5g;

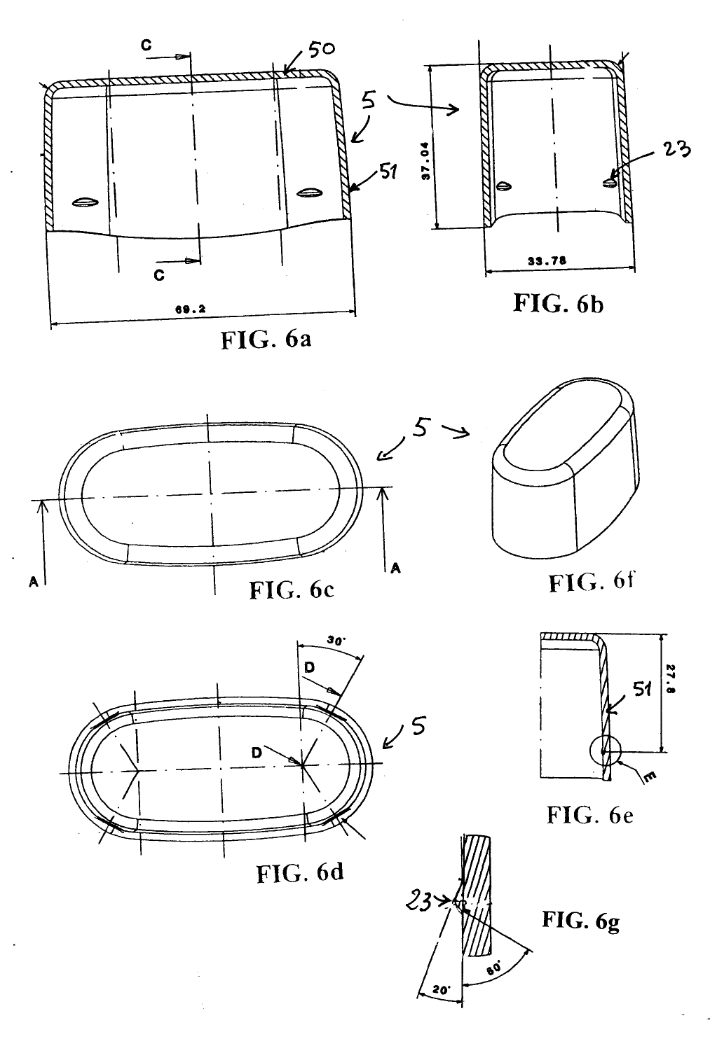

a cap 5 according to the drawings of FIGS. 6a to 6g, the cap also including at least one axial projection 501, as shown in FIGS. 2a and 2b, so as to then attach an upper magnet 52;

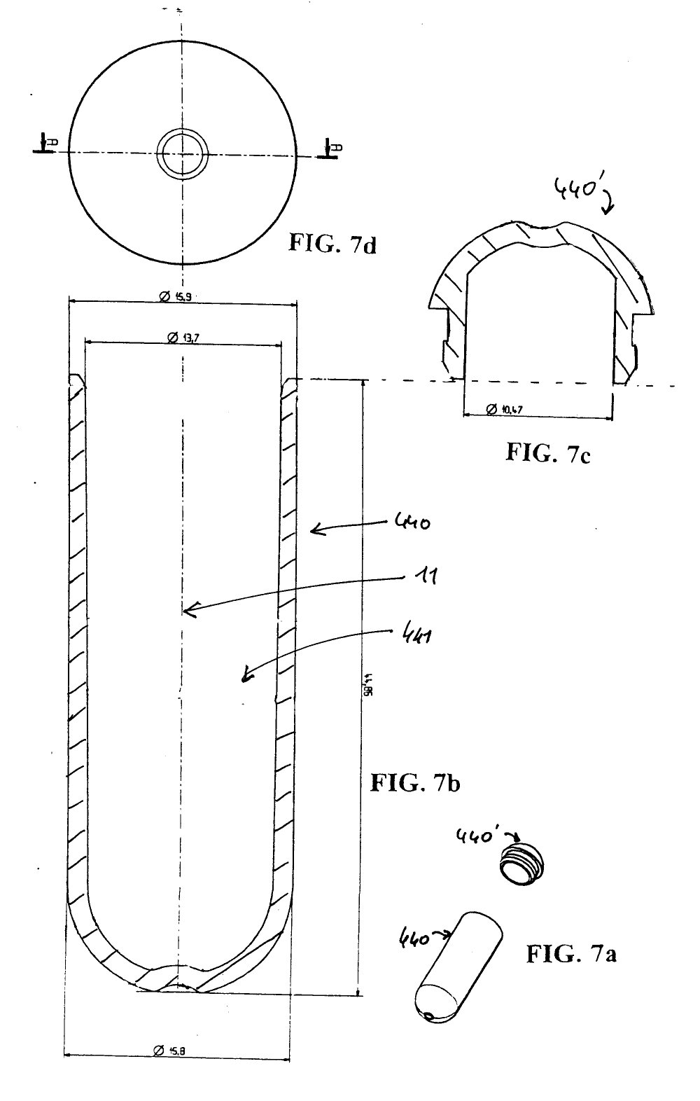

two hollow half-shells 440, 440′, according to the drawings of FIGS. 7a to 7d, so as to be capable of then forming said hollow roller 44, 44′″;

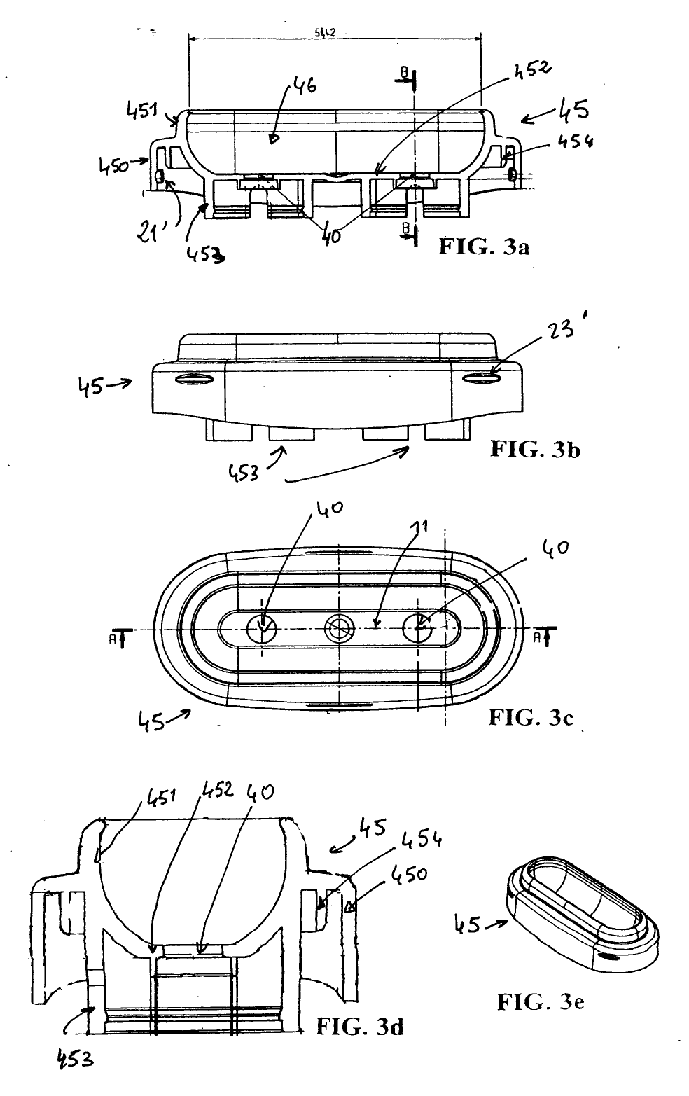

a support 45, intended to receive said hollow roller 44, 44′″, according to the drawings of FIGS. 3a to 3e;

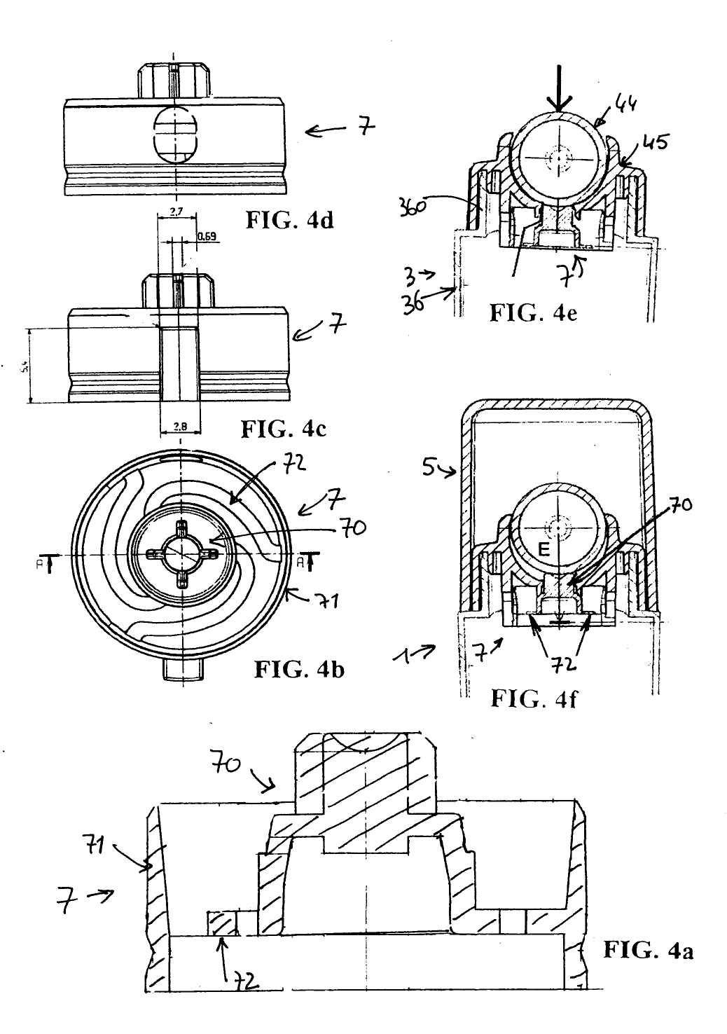

two valves 7 according to the drawings of FIGS. 4a to 4f.

The support 44 includes an upper peripheral lip 451 defining an upper cavity 46 capable of housing said hollow roller 44′″ forming said rotatable part 44, a circular lip 450 ensuring sealed cooperation with the upper end of the skirt 36 of said container, and a base 452 including annular projections 453 making it possible to integrate the valves 7 capable of closing off the openings 40 formed on the base 452.

The support also includes an axial projection 454 intended to provide a solid and sealed connection between said container 3 and said application means 4, the upper end 360 of said skirt 36 being entrapped between said circular lip 450 and said axial projection 454, as shown in FIGS. 1a to 1c.

The parts constituting said vibration generating device 6 were supplied, in particular:

a vibration generator 60 according to the drawings of FIGS. 2c to 2f;

two flat batteries as a power source 61;

an electric circuit 62 connecting the batteries to the generator;

a switch 63 formed by electrical contact between a pole of the batteries and an element integrated with a lower magnet 66 capable of moving transversely;

a return spring 67 intended to cooperate with the lower magnet 66.

These parts were assembled in the half-shell 440, then the other half-shell 440′ was snapped on, so as to obtain a hollow roller 44′″ forming a secondary cavity 441 in which said vibration generating device 6 was housed.

Next, to form a sub-assembly of parts, the following parts were then assembled: the following were assembled to the support 45: the hollow roller 44′″ equipped with said vibration generating device 6, the two valves 7, and the cap 5, using the snap-on means 23, 23′ which can be seen in FIGS. 3b and 6b.

After filling the container 3, 3″ with product 9 by the top, the container 3, 3″ was closed off by axially snapping the sub-assembly of parts described above onto the container 3, 3″ using the snap-on means 21, 21′ which can be seen in FIGS. 3a and 5e.

### EXAMPLE 2A

This example describes producing a plurality of alternative distributor-applicators 1 with a cylindrical shape and an H/D ratio greater than 4 were also produced, as shown in FIGS. 8a to 8f, with H being equal to 88 mm and D being equal to 19.75 mm.

To do this, a vibration generating device 6 including a box 68 containing the parts constituting said generator was produced, the electrical contact capable of being established by a manual axial pressure exerted on the upper portion of the box 68, in the alternative of FIG. 8f, or on the lower portion of the box, in the case of the alternatives of FIGS. 8b, 8c, 8d and 8e.

In all of these alternatives according to FIGS. 8b to 8f, the box 68 is housed in the so-called main cavity 30 of the container 3, the base of the container being closed off by an end cap 32.

### EXAMPLE 2B

The alternative according to FIG. 8b was produced. In this alternative:

the application means 4 form a distinct part of said body 3 and include a central membrane 42 forming said application surface 41 equipped with an upper opening 40, and a peripheral portion 43 capable of being snapped onto said body 3, 3′;

the cap 5 includes a first projection 500 intended to close off the upper opening 40 when the distributor-applicator 1 is closed;

the vibration generating device 6 includes an axial rod 64′ as vibration transmission means 64.

In this alternative, the filling of the container can be done either by the top or by the bottom.

When it is done by the top, a first sub-assembly of parts is formed, including the cap 5 and the application means 4 snapped on, the second sub-assembly of parts including the container 3 equipped with the end cap 32 and the vibration generating device 6.

When it is done by the bottom, a first sub-assembly of parts is formed, including the cap 5, the application means 4 and the body 3 snapped on, the second sub-assembly including the closure means 32 integrated with said box 68 equipped with said rod 64′.

The vibration generating device 6 is activated by manual pressure on the closure means 32 and functions as long as said pressure is exerted, said manual pressure closing said circuit 62 by an electrical contact forming a switch 63. Said closure means 32 are closure means with elastic return 32′ including a flexible membrane with elastic return, which returns to its initial position once said manual pressure ceases.

Said manual pressure urges said membrane toward the inside of said container 3, thereby also having the effect of causing a predetermined amount of said product to flow through said upper opening 40, said distributor 1 being in the upside-down position, with said application means 4 positioned below said container 3.

### EXAMPLE 2C

Next the alternative of FIG. 8c was produced. In this alternative:

said application means 4 include a rotatable part 44 forming a ball 44′, and a support 45 snapped onto the upper portion of the body 3;

the skirt 51 of the cap 5 is a threaded skirt 51′ that cooperates with an upper threaded portion of said body 3;

the cap includes a first axial projection 500′ that exerts an axial pressure on said ball 44′ so as to push said ball against the support 45 and thus close off the upper opening 33 of said container 3;

said box 68 includes, as transmission means 64, an axial rod 64′ and a plurality of oblique rods 64″ coming into contact with a shoulder of said body 3;

said rod 64′ includes, at its upper end, a plunger 80′ capable of sliding into a lower cavity 47 forming a secondary container or a measuring chamber placed under said ball 44′, so that said manual pressure exerted on said closure means 32, as in the case of the distributor according to FIG. 8b, urges a predetermined amount of said product toward said ball 44′;

said oblique rods 64″ form elastic lugs that have a flexibility making it possible to contribute, entirely or partially, to the elastic return of said box 68 and said closure means 32, when said manual pressure ceases.

### EXAMPLE 2D

The alternative according to FIG. 8d was produced. This alternative is similar to that of FIG. 8c and differs therefrom by the absence of an axial rod 64′ on which a plunger 80′ is mounted.

### EXAMPLE 2E

The alternative of FIG. 8e was produced. As in the alternative of FIG. 8b, the application means 4 include a central membrane 42 forming said application surface 41 equipped with a central upper opening 40, but, unlike this alternative, the central membrane and said body 3 form a one-piece moulded part 20;

the cap 5 includes a first central projection 500 intended to close off the central upper opening 40, when the distributor-applicator 1 is closed;

as in the alternative of FIG. 8d, said box 68 includes, as transmission means 64, an axial rod 64′ and a plurality of oblique rods 64″ forming elastic lugs coming into contact with a shoulder of said body 3 and can contribute to the elastic return of said box 68 and said closure means 32 when said manual pressure ceases.

### EXAMPLE 2F

The alternative according to FIG. 8f was produced. This alternative is similar to the alternative of FIG. 8b. It differs therefrom in that said box 68 was directly integrated with said central membrane 42.

### EXAMPLE 2G

The alternative of FIGS. 10a and 10b was produced. In this alternative:

the closed distributor forms a cylindrical body having a diameter of 18.75;

said container 3, 3″ includes, in its upper portion, a central tubular conduit 35 of which the upper end cooperates with said central membrane so as to form said upper opening 40, which upper opening 40 is closed off by the lower end of said first axial projection 500 of said cap 5;

the vibration generating device is housed in a space located between said application means 4 and said container 3, and said switch 63 is a push button 63″ placed laterally, at the upper end of the skirt 36 of said container 3;

the skirt 51 of the cap is a threaded skirt 51′ equipped with an internal threading cooperating with an external threading formed on said rigid peripheral part 43.

### EXAMPLE 3A

Distributor-applicators 1 equipped with means for propulsion 8 of the product 9 were also produced. According to a first alternative, a distributor body 2, as shown in FIGS. 9a and 9b, was produced. In this alternative:

said application means 4 include a rotatable part 44 forming a ball 44′, and said support 45 is formed by an upper portion 34 of the body 3;

the propulsion means 8 include the cooperation of a plunger 80 and a micro-notched rod 81′, as shown in FIG. 9b, said rod 81′ also forming said vibration transmission means 64′, so that the vibrations drive said plunger 80 upward by a progressive axial movement;

the closure means 32 of the body 3 are formed by said box 68 containing said vibration generating device 6.

### EXAMPLE 3B

According to a second alternative, a distributor body as shown in FIGS. 9d and 9e was produced. This alternative differs from the previous one in that the propulsion means include a threaded rod 81″ cooperating with a plunger 80, the threaded rod 81″ being driven in rotation by a rotation button 83 also forming said closure means 32, and said box 68 including said vibration generating device 6.

### LIST OF REFERENCES

Distributor applicator 1
Axial direction 10
Transverse direction 11
Body of 1 2
Body forming a tube 2′
One-piece moulded part 4+3 20
Axial snap-on means of 3 and 4 21, 21′
Base of tube 2′ 22
Snap-on means of 5 and 45 23, 23′
Container of 2 3
Container with lower opening 3′
Container without lower opening 3″
Main cavity 30
Lower opening 31
Closure means of 31 32
Closure means with elastic return 32′
Upper opening 33
Upper portion acting as support 34
Central tubular conduit 35
Skirt of 3, 3′, 3″ 36
Upper end of 36 360
Application means of 2 4
Upper opening 40
Application surface 41
Central membrane (flexible) 42
Relief portion 420
Hollow portion 421
Peripheral portion (rigid) 43
Rotatable part 44
Ball 44′
Longitudinal part or roller 44″
Hollow roller 44′″
Hollow half-shell 440, 440′
Secondary cavity 441
Support of 44 45
Circular lip 450
Upper peripheral lip 451
Base 452
Annular projection 453
Upper cavity 46
Lower cavity forming a secondary container 47
Cap of 1 5
Head 50
First axial projection (closure) 500, 500′
Second axial projection (contact) 501
Skirt 51
Threaded skirt 51′
Upper magnet 52
Vibration generating device 6
Vibration generator 60
Electric motor 600
Motor spindle 601
Unbalanced part mounted on 601 602
Contact for powering of 600 603
Power source 61
Electric circuit 62
Switch 63
Automatic switch 63′
Push button 63″
Transmission means, rod 64, 64′, 64″
Mobile element of 63 65
Lower magnet 66
Return spring 67
Box containing at least 60 68
Valve 7
Central portion acting as closure 70
Peripheral assembly part 71
Intermediate portion with spring force 72
Produce propulsion means 8
Plunger 80, 80′
Axial rod 81
Micro-notched rod 81′
Threaded rod 81″
Non-return means 82
Button for rotation of 81 83
Fluid or pasty product 9

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention and described and claimed herein.

We claim:

1. A distributor-applicator for a fluid or pasty product, the distributor-applicator having an axial direction and comprising:
a body having a container forming a main cavity capable of containing said product, the main cavity having an upper portion; and
application means integrated with said container, closing off said main cavity at its upper portion, said application means being capable of being in communication with said container so that said application means can be supplied with said product, and including an application surface for application of said product, and a cap equipped with a head and a skirt cooperating with said body to protect said application means when said distributor-applicator is not being used;
wherein said body includes a vibration generator, a power source, an associated electric circuit for supplying power to said vibration generator, and a switch for starting and stopping said generator, so that, during application of said product said application means can produce a massaging effect;
wherein said switch includes a mobile element for switching off said electric circuit, said mobile element being capable of switching from an open position to a closed position to open and close said electric circuit, and said cap cooperating with said mobile element to form an automatic switch, said electric circuit being open when said cap cooperates with said body, and said electric circuit being closed when said cap is separated from said body, so that said vibration generator functions when said cap is separated from said body, said vibration generator automatically stopping when said cap is secured to said body.

2. A distributor-applicator according to claim 1, wherein said vibration generator is integrated with said body, said vibrations transmitted by said vibration generator being transmitted from said body to said application means.

3. A distributor-applicator according to claim 2, wherein said vibration generator includes a rod integrated at one end with said vibration generator and at the other end with said application means for transmitting vibrations to said application means.

4. A distributor-applicator according to claim 1, wherein said vibration generator is integrated with the application means so as to directly transmit said vibrations from said vibration generator to said application means.

5. A distributor-applicator according to claim 1, wherein said application means includes a central membrane capable of responding to the mechanical stresses imposed by said vibration generator, said central membrane including at least said upper opening in communication with said container.

6. A distributor-applicator according to claim 5, wherein said central membrane forms all or a portion of a distinct part of said container, said application means including a peripheral portion to cooperate with an upper opening of said container.

7. A distributor-applicator according to claim 5, wherein said central membrane forms a one-piece part integrated with all or a portion of said container.

8. A distributor-applicator according to claim 5, wherein said central membrane has a relief, with relief portions and hollow portions, so as to obtain a massaging effect.

9. A distributor-applicator according to claim 5, wherein the head of said cap includes a first axial projection capable of closing off said upper opening when said cap cooperates with said body.

10. A distributor-applicator for a fluid or pasty product, the distributor-applicator having an axial direction and comprising:
a body having a container forming a main cavity capable of containing said product, the main cavity having an upper portion; and
application means integrated with said container, closing off said main cavity at its upper portion, said application means having a mobile part rotatable with respect to said container, and a support for said mobile part equipped with an opening enabling communication between said container and said mobile part, wherein said support cooperates with said mobile part so that said mobile part can rotate about itself during application of said product to transfer said product from said container to an application surface;
wherein said body includes a vibration generator, a power source, an associated electric circuit for supplying power to said vibration generator, and a switch for starting and stopping said generator, so that, during application of said product said application means can produce a massaging effect;
wherein said switch includes a mobile element for switching off said electric circuit, said mobile element being capable of switching from an open position to a closed position to open and close said electric circuit, and said cap cooperating with said mobile element to form an automatic switch, said electric circuit being open when said cap cooperates with said body, and said electric circuit being closed when said cap is separated from said body, so that said vibration generator functions when said cap is separated from said body, said vibration generator automatically stopping when said cap is secured to said body.

11. A distributor-applicator according to claim 10, wherein said mobile part is formed by at least one ball, said support including at least one circular lip or a plurality of lugs surrounding said ball so that said ball can rotate about itself without being separated from said support.

12. A distributor-applicator according to claim 10, wherein said mobile part is formed by a longitudinal part or a roller capable of rotating about itself in a transverse direction perpendicular to said axial direction, said support including an upper cavity equipped with an upper peripheral lip, having a shape matching that of said roller, so that said roller can be snapped into said upper cavity, and said roller, once snapped into said upper cavity, has, with respect to said support, a sufficient play to allow for rotation of said roller in said transverse direction when said product is applied.

13. A distributor-applicator according to claim 12, wherein said roller is a hollow roller formed by an assembly of two hollow half-shells to form a secondary cavity when the two hollow half-shells are assembled.

14. A distributor-applicator for a fluid or pasty product, the distributor-applicator having an axial direction and comprising:
a body having a container forming a main cavity capable of containing said product, the main cavity having an upper portion; and
application means integrated with said container, closing off said main cavity at its upper portion, said application means including an application surface for application of said product, and a cap equipped with a head and a skirt cooperating with said body to protect said application means when said distributor-applicator is not being used, wherein the head of said cap includes a first axial projection capable of closing off said upper opening when said cap cooperates with said body;
wherein said body includes a vibration generator, a power source, an associated electric circuit for supplying power to said vibration generator, and a switch for starting and stopping said generator, so that, during application of said product said application means can produce a massaging effect;
wherein said switch includes a mobile element for switching off said electric circuit, said mobile element being capable of switching from an open position to a closed position to open and close said electric circuit, and said cap cooperating with said mobile element to form an automatic switch, said electric circuit being open when said cap cooperates with said body, and said electric circuit being closed when said cap is separated from said body, so that said vibration generator functions when said cap is separated from said body, said vibration generator automatically stopping when said cap is secured to said body;
wherein said cap includes a second axial projection having an upper magnet, and said mobile element includes a lower magnet, wherein said upper magnet and lower magnet are arranged so that said upper magnet drives a movement of said lower magnet forming said mobile element to the open position when said cap cooperates with said body, and a return spring causes said mobile element to move to the closed position when said cap is separated from said body.

15. A distributor-applicator according to claim 14, wherein said vibration generator transmits periodic vibrations with a frequency ranging from about 20 Hz to 60 Hz.

16. A distributor-applicator according to claim 14, wherein said vibration generator transmits axial vibrations in said axial direction.

17. A distributor-applicator according to claim 14, wherein said vibration generator transmits transverse vibrations in said transverse direction.

18. A distributor-applicator according to claim 17, wherein said container includes a plunger for propulsion of said product toward said application means.

19. A distributor-applicator according to claim 18, wherein said plunger is moved axially in said container by said axial vibrations, with an axial rod integrated with said vibration generator and transmitting to said plunger a series of axial micro-movements, owing to non-return means preventing said plunger, after each micro-movement in the direction of said application means, from moving backward, so as to automatically supply said application means with product, regardless of the orientation of said container or the viscosity of said product.

20. A distributor-applicator according to claim 19, wherein said container includes a base without an opening, said container including said upper opening making it possible to fill said container by the top, said application means being assembled to said container after filling said container by the top;
wherein said opening of said support cooperates with a closure valve capable of moving with respect to said opening according to an axial path over an axial distance ranging from 0.5 to 3 mm, said valve including a central portion intended to close off said opening, a peripheral portion ensuring assembly with said support, an intermediate portion having an elastic return with a spring force urging said central portion toward said mobile part, so that said opening is closed off by said central portion when said mobile part exerts an axial pressure on said central portion.
